(19) United States
(12) Patent Application Publication
(10) Pub. No.: US 2025/0174185 A1
(43) Pub. Date: May 29, 2025

(54) METHOD OF COMPENSATING IMAGE STICKING IN A DISPLAY DEVICE AND ELECTRONIC DEVICE INCLUDING A DISPLAY DEVICE

(71) Applicant: Samsung Display Co., LTD., Yongin-si (KR)

(72) Inventors: TAEWAN KIM, Yongin-si (KR); HWAAN SUNG, Yongin-si (KR); CHUL SHIN, Yongin-si (KR); JIYOUNG EOM, Yongin-si (KR); JEONGAH LEE, Yongin-si (KR); DAEHO HWANG, Yongin-si (KR)

(21) Appl. No.: 18/942,167

(22) Filed: Nov. 8, 2024

(30) Foreign Application Priority Data
Nov. 24, 2023 (KR) 10-2023-0165684

(51) Int. Cl. G09G 3/3208; G09G 3/32

(52) U.S. Cl. CPC G09G 3/3208; G09G 3/32; G09G 2320/0233; G09G 2320/045; G09G 2320/046; G09G 2352/00

(57) ABSTRACT

A method of compensating image sticking in a display device includes storing image-sticking compensation data representing a compensation value according to a degradation amount of a pixel, performing an image-sticking compensation operation on test data based on the image-sticking compensation data, displaying a test image based on the test data, receiving a miscompensation region input representing a miscompensation region in the test image, receiving a relative brightness input representing whether the miscompensation region is brighter or darker than a remaining region of the test image that is other than the miscompensation region, and determining an additional compensation value for the pixel in the miscompensation region based on the degradation amount of the pixel in the miscompensation region, based on the miscompensation region input, and based on the relative brightness input.

### CROSS-REFERENCE TO RELATED APPLICATION(S)

The present application claims priority to, and the benefit of, Korean Patent Application No. 10-2023-0165684, filed on Nov. 24, 2023, in the Korean Intellectual Property Office (KIPO), the entire disclosure of which is incorporated herein by reference.

### BACKGROUND

### 1. Field

Embodiments of the present disclosure relate to a method of compensating image sticking in a display device, and to an electronic device including the display device.

### 2. Description of the Related Art

With the development of information technologies, the importance of a display device, which is a connection medium between a user and information, has increased. Accordingly, display devices, such as liquid crystal display devices, organic light-emitting display devices, and plasma display panels, are increasingly used. Among these display devices, an organic light-emitting display device displays an image using an organic light-emitting diode that generates light by recombination of electrons and holes. The organic light-emitting display device has a relatively high response speed and are driven with relatively low power consumption.

However, when an organic light-emitting display device displays a fixed image for a long time, image sticking (or mura) may be perceived in an image displayed by the organic light-emitting display device due to burn-in of organic light-emitting diodes included in the organic light-emitting display device. To remove or reduce this image sticking, an image-sticking compensation operation may be performed by determining a compensation value corresponding to a degradation amount (or a driving time) of each pixel based on image-sticking compensation data (or an image-sticking compensation curve) and by increasing a gray level of image data for each pixel by the compensation value. However, because the same image-sticking compensation data (or the same image-sticking compensation curve) is applied to different display devices, the image sticking may be overcompensated or undercompensated based on the same image-sticking compensation data in at least a portion of the display devices due to a driving environment (e.g., temperature, ambient light, etc.), a panel distribution, or the like.

### SUMMARY

Some embodiments provide a method of compensating image sticking in a display device based on an input from a user.

Some embodiments provide an electronic device including a display device that compensates image sticking based on an input from a user.

According to embodiments, there is provided a method of compensating image sticking in a display device, the method including storing image-sticking compensation data representing a compensation value according to a degradation amount of a pixel, performing an image-sticking compensation operation on test data based on the image-sticking compensation data, displaying a test image based on the test data, receiving a miscompensation region input representing a miscompensation region in the test image, receiving a relative brightness input representing whether the miscompensation region is brighter or darker than a remaining region of the test image that is other than the miscompensation region, and determining an additional compensation value for the pixel in the miscompensation region based on the degradation amount of the pixel in the miscompensation region, based on the miscompensation region input, and based on the relative brightness input.

The method may further include determining that the miscompensation region is an overcompensation region based on the relative brightness input indicating that the miscompensation region is brighter than the remaining region.

The additional compensation value for the pixel in the overcompensation region may be a negative value.

An absolute value of the additional compensation value for the pixel in the overcompensation region may increase as the degradation amount of the pixel increases.

Determining the additional compensation value for the pixel in the miscompensation region may include determining a first additional compensation value for a first pixel having a first degradation amount in the overcompensation region, and determining a second additional compensation value for a second pixel having a second degradation amount that is greater than the first degradation amount in the overcompensation region, wherein the first and second additional compensation values are negative values, and wherein an absolute value of the second additional compensation value is greater than an absolute value of the first additional compensation value.

The method may further include determining that the miscompensation region is an undercompensation region based on the relative brightness input indicating that the miscompensation region is darker than the remaining region.

The additional compensation value for the pixel in the undercompensation region may be a positive value.

An absolute value of the additional compensation value for the pixel in the undercompensation region may increase as the degradation amount of the pixel increases.

Determining the additional compensation value for the pixel in the miscompensation region may include determining a first additional compensation value for a first pixel having a first degradation amount in the undercompensation region, and determining a second additional compensation value for a second pixel having a second degradation amount that is greater than the first degradation amount in the undercompensation region, wherein the first and second additional compensation values are positive values, and wherein an absolute value of the second additional compensation value is greater than an absolute value of the first additional compensation value.

The test data may represent a same gray level for an entire region of a display panel.

The method may further include re-performing the image-sticking compensation operation on the test data based on the image-sticking compensation data and based on the additional compensation value, displaying a corrected test image based on the test data on which the image-sticking compensation operation is re-performed, and receiving a visibility evaluation input for the corrected test image.

The method may further include storing the additional compensation value for the pixel in the miscompensation region based on the visibility evaluation input indicating that the corrected test image has good visibility.

The method may further include re-determining the additional compensation value for the pixel in the miscompensation region by again receiving the miscompensation region input and the relative brightness input based on the visibility evaluation input indicating that the corrected test image has poor visibility.

According to embodiments, there is provided a method of compensating image sticking in a display device, the method including storing image-sticking compensation data representing a compensation value according to a degradation amount of a pixel, performing an image-sticking compensation operation on test data based on the image-sticking compensation data, displaying a test image based on the test data, receiving a miscompensation region input representing a miscompensation region in the test image, receiving a relative brightness input representing whether the miscompensation region is brighter or darker than a remaining region in the test image that is other than the miscompensation region, receiving a brightness level input representing a brightness level or a darkness level of the miscompensation region, and determining an additional compensation value for the pixel in the miscompensation region based on the degradation amount of the pixel in the miscompensation region, based on the miscompensation region input, based on the relative brightness input, and based on the brightness level input.

An absolute value of the additional compensation value for the pixel in the miscompensation region may increase as the brightness level input increases.

According to embodiments, there is provided an electronic device including an input device, and a display device including a display panel, and a panel driver configured to drive the display panel, configured to store image-sticking compensation data representing a compensation value according to a degradation amount of a pixel of the display panel, configured to perform an image-sticking compensation operation on test data based on the image-sticking compensation data, and configured to drive the display panel to display a test image based on the test data, wherein the input device is configured to receive a miscompensation region input representing a miscompensation region in the test image, and is configured to receive a relative brightness input representing whether the miscompensation region is brighter or darker than a remaining region in the test image that is other than the miscompensation region, and wherein the panel driver is configured to determine an additional compensation value for the pixel in the miscompensation region based on the degradation amount of the pixel in the miscompensation region, based on the miscompensation region input, and based on the relative brightness input.

The panel driver may be configured to determine that the miscompensation region is an overcompensation region based on the relative brightness input indicating that the miscompensation region is brighter than the remaining region, or may be configured to determine that the miscompensation region is an undercompensation region based on the relative brightness input indicating that the miscompensation region is darker than the remaining region.

The additional compensation value for the pixel in the overcompensation region may be a negative value, or may be a positive value.

An absolute value of the additional compensation value for the pixel in the miscompensation region may increase as the degradation amount of the pixel increases.

The panel driver may be configured to receive a brightness level input representing a brightness level or a darkness level of the miscompensation region, wherein an absolute value of the additional compensation value for the pixel in the miscompensation region increases as the brightness level input increases.

As described above, in a method of compensating image sticking in a display device, and in an electronic device including the display device, according to embodiments, a miscompensation region input and a relative brightness input may be received from a user, and an additional compensation value for pixels in a miscompensation region (or an abnormal compensation region, such as an overcompensation region and/or an under compensation region) may be determined based on a degradation amount, the miscompensation region input, and the relative brightness input. Accordingly, image sticking may be removed or reduced in the display device, and an image quality of the display device may be improved.

### BRIEF DESCRIPTION OF THE DRAWINGS

Illustrative, non-limiting embodiments will be more clearly understood from the following detailed description in conjunction with the accompanying drawings.

FIG. 1 is a flowchart illustrating a method of compensating image sticking in a display device according to embodiments.

FIG. 2 is a diagram illustrating a luminance of each pixel according to a degradation amount of the pixel.

FIG. 3 is a diagram for describing an example of an image-sticking compensation operation.

FIG. 4 is a diagram for describing an example in which an image-sticking compensation region is selected in a test image.

FIG. 5 is a diagram for describing an example of additional compensation values for pixels having different degradation amounts in an overcompensation region.

FIG. 6 is a diagram for describing an example of additional compensation values for pixels having different degradation amounts in an undercompensation region.

FIG. 7 is a flowchart illustrating a method of compensating image sticking in a display device according to embodiments.

FIG. 8 is a diagram for describing an example of additional compensation values for pixels in an overcompensation region in cases where different brightness level inputs are received.

FIG. 9 is a diagram for describing an example of additional compensation values for pixels in an undercompensation region in cases where different brightness level inputs are received.

FIG. 10 is a block diagram illustrating an electronic device including a display device according to embodiments.

FIG. 11 is a block diagram illustrating an example of an electronic device according to embodiments.

### DETAILED DESCRIPTION OF THE EMBODIMENTS

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure. The present disclosure covers all modifications, equivalents, and replacements within the idea and technical scope of the present disclosure. Further, each of the features of the various embodiments of the present disclosure may be combined with each other, in part or in whole, and technically various interlocking and driving are possible. Each embodiment may be implemented independently of each other or may be implemented together in an association.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the term “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

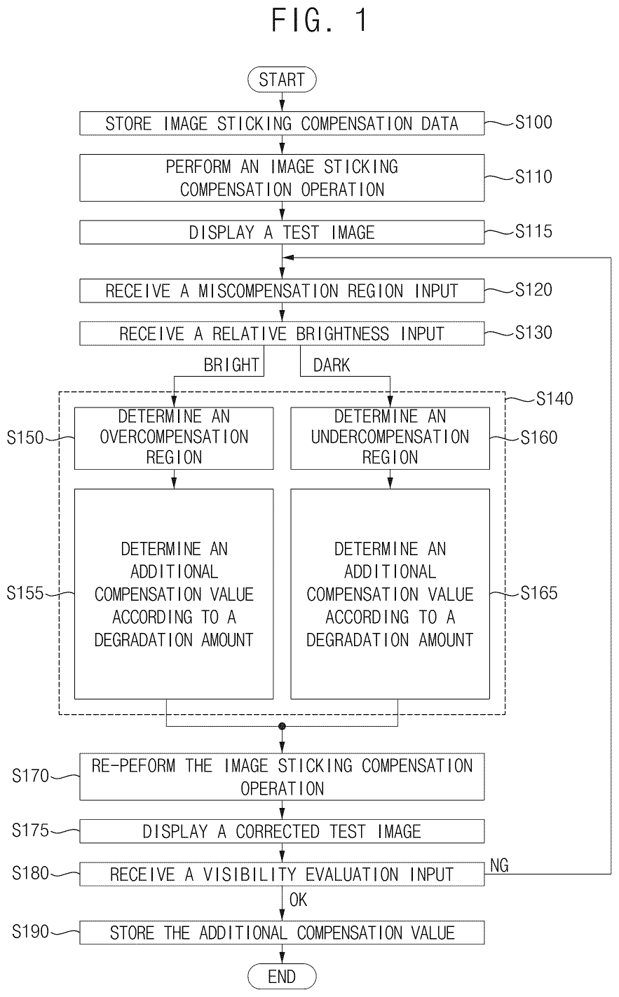

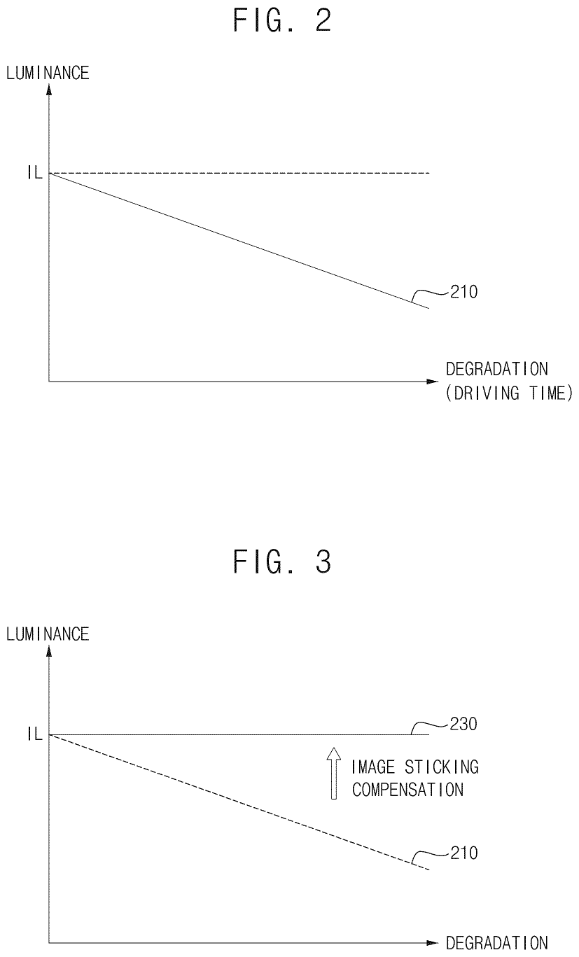

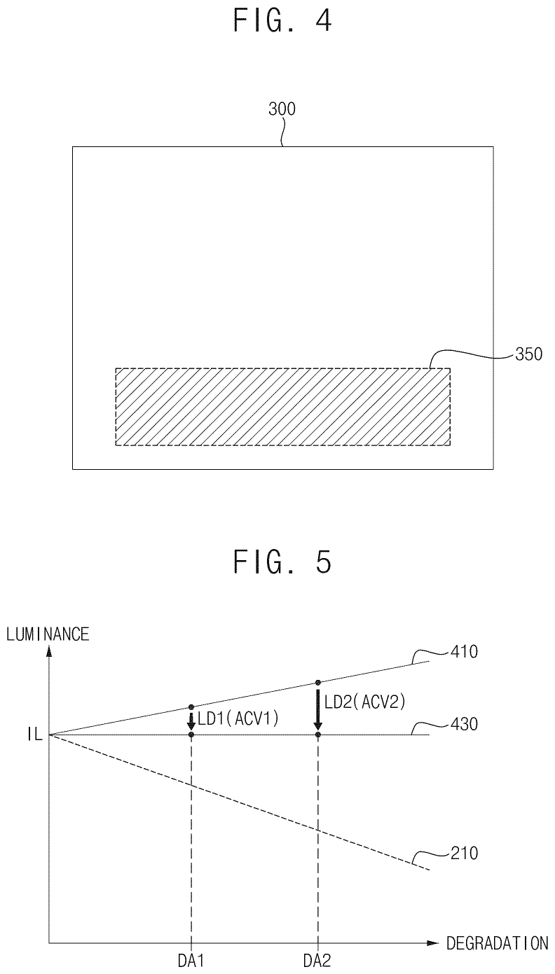

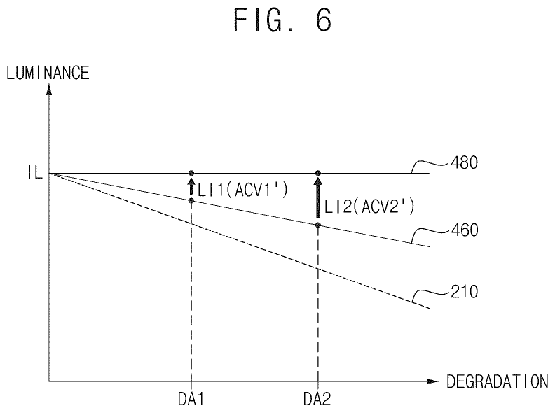

FIG. 1 is a flowchart illustrating a method of compensating image sticking in a display device according to embodiments, FIG. 2 is a diagram illustrating a luminance of each pixel according to a degradation amount of the pixel, FIG. 3 is a diagram for describing an example of an image-sticking compensation operation, FIG. 4 is a diagram for describing an example in which an image-sticking compensation region is selected in a test image, FIG. 5 is a diagram for describing an example of additional compensation values for pixels having different degradation amounts in an overcompensation region, and FIG. 6 is a diagram for describing an example of additional compensation values for pixels having different degradation amounts in an undercompensation region.

Referring to FIG. 1, in a method of compensating image sticking in a display device according to embodiments, the display device may store image-sticking compensation data (or an image-sticking compensation curve) representing a compensation value according to a degradation amount of each pixel of the display device (S100). FIG. 2 illustrates an example of a luminance 210 of each pixel of the display device according to the degradation amount (or a driving time) of each pixel. As illustrated in FIG. 2, the luminance 210 of each pixel may be decreased from an initial luminance IL as the degradation amount increases.

To compensate for the decrease in luminance due to degradation of each pixel, the display device may store the image-sticking compensation data, and may perform an image-sticking compensation operation based on the image-sticking compensation data. For example, with respect to each pixel of the display device, the display device may perform the image-sticking compensation operation that compensates for the decrease in luminance by adding the compensation value corresponding to the degradation amount of the pixel represented by the image-sticking compensation data to a gray level represented by input image data. Further, for example, as illustrated in FIG. 3, the display device may perform the image-sticking compensation operation based on the image-sticking compensation data indicating the compensation value that increases as the degradation amount increases, and thus the luminance 210 of each pixel may be increased to a luminance 230 that is substantially the same as the initial luminance IL.

Further, in the method of compensating the image sticking according to embodiments, the display device may perform the image-sticking compensation operation on test data based on the image-sticking compensation data (S110), and may display a test image based on the test data on which the image-sticking compensation operation is performed (S115). In some embodiments, the test data may represent the same gray level for the entire region of a display panel of the display device. For example, the test data may represent one of 96 to 127 gray levels, but is not limited thereto. Further, the display device may perform the image-sticking compensation operation that adds the compensation value corresponding to the degradation amount of each pixel to the same gray level indicated by the test data.

It may be suitable that the test image, which is displayed based on the test data on which the image-sticking compensation operation is performed, has a constant luminance 230 for pixels having different degradation amounts, as illustrated in FIG. 3. However, the same image-sticking compensation data (or the same image-sticking compensation curve) may be applied to different display devices, and thus the decrease in luminance due to degradation of each pixel may not be accurately compensated to the initial luminance IL in some of the display devices due to a driving environment (e.g., temperature, ambient light, etc.), a panel distribution, etc. That is, in some of the display devices, the image sticking may be overcompensated based on the same image-sticking compensation data such that at least a portion of the test image may have a luminance 410 that is higher than the initial luminance IL, as illustrated in FIG. 5, or may be undercompensated based on the same image-sticking compensation data such that at least a portion of the test image may have a luminance 460 that is lower than the initial luminance IL, as illustrated in FIG. 6. Further, the overcompensation or the undercompensation of the image-sticking compensation operation based on the image-sticking compensation data may become more severe as the degradation amount of each pixel increases, as illustrated in FIGS. 5 and 6.

In the method of compensating the image sticking according to embodiments, to compensate for the miscompensation of the image-sticking compensation operation based on the image-sticking compensation data, the display device may receive a miscompensation region input, which represents a miscompensation region in the test image, from a user through an input device (e.g., predetermined input device) (S120). For example, as shown in FIG. 4, the user may select the miscompensation region 350 having higher or lower luminance than a remaining region in the test image 300 through the input device (e.g., predetermined input device), and the display device may receive the miscompensation region input representing the miscompensation region 350. Although FIG. 4 illustrates an example in which the miscompensation region 350 has a rectangular shape, the shape of the miscompensation region 350 selected by the user is not limited to the rectangular shape. Further, in some embodiments, the input device (e.g., predetermined input device) may be, but is not limited to, a remote controller when the electronic device including the display device is a television, a mouse when the electronic device including the display device is a personal computer or a laptop computer, a touch screen when the display device includes the touch screen, etc.

Further, the display device may further receive a relative brightness input representing whether the miscompensation region is brighter or darker than the remaining region, which is other than the miscompensation region, from the user through the input device (e.g., predetermined input device) (S130). That is, the relative brightness input may indicate that the miscompensation region is brighter than the remaining region, or may indicate that the miscompensation region is darker than the remaining region.

The display device may determine an additional compensation value for each pixel in the miscompensation region based on the degradation amount of each pixel in the miscompensation region, based on the miscompensation region input, and based on the relative brightness input (S140).

If the miscompensation region is brighter than the remaining region (BRIGHT), the display device may determine that the miscompensation region is an overcompensation region (S150). That is, based on the relative brightness input indicating that the miscompensation region is brighter than the remaining region, the display device may determine that each pixel in the miscompensation region has a luminance 410 that is higher than the initial luminance IL, as illustrated in FIG. 5, and that miscompensation region is the overcompensation region. Thus, the display device may determine the additional compensation value that is a negative value for each pixel in the overcompensation region to decrease the luminance 410 of each pixel in the overcompensation region.

Further, with respect to each pixel in the overcompensation region, the display device may determine the additional compensation value according to the degradation amount of the pixel (S155). In some embodiments, the display device may determine the additional compensation value for the pixel such that the absolute value of the additional compensation value increases as the degradation amount of the pixel in the overcompensation region increases.

FIG. 5 illustrates an example of the luminance 410 of the overcompensation region, and an example of a luminance 430 adjusted by the additional compensation value. For example, as illustrated in FIG. 5, in the overcompensation region, the luminance 410 of each pixel may be higher than the initial luminance IL by an amount that increases as the degradation amount of the pixel increases. Thus, the display device may determine a first additional compensation value ACV1 that is a negative value for a first pixel having a first degradation amount DA1 in the overcompensation region. Further, the display device may determine a second additional compensation value ACV2 that is a negative value for a second pixel having a second degradation amount DA2 that is greater than the first degradation amount DA1 in the overcompensation region. An absolute value of the second additional compensation value ACV2 may be greater than an absolute value of the first additional compensation value ACV1. Thus, the luminance of the first pixel may be decreased by a first luminance decrease amount LD1 by the first additional compensation value ACV1, and thus may become substantially equal to the initial luminance IL. Further, the luminance of the second pixel may be decreased by a second luminance decrease amount LD2 that is greater than the first luminance decrease amount LD1 by the second additional compensation value ACV2, and thus may become substantially equal to the initial luminance IL. Accordingly, the luminance 410 of the overcompensation region may become the luminance 430 that is substantially the same as the initial luminance IL.

Alternatively, referring to FIG. 1, if the miscompensation region is darker than the remaining region (DARK), the display device may determine that the miscompensation region is an undercompensation region (S160). That is, based on the relative brightness input indicating that the miscompensation region is darker than the remaining region, the display device may determine that each pixel in the miscompensation region has a luminance 460 that is lower than the initial luminance IL as illustrated in FIG. 6, and that miscompensation region is the undercompensation region. Thus, the display device may determine the additional compensation value is a positive value for each pixel in the undercompensation region to increase the luminance 410 of each pixel in the undercompensation region.

Further, with respect to each pixel in the undercompensation region, the display device may determine the additional compensation value according to the degradation amount of the pixel (S165). In some embodiments, the display device may determine the additional compensation value for the pixel such that the absolute value of the additional compensation value increases as the degradation amount of the pixel in the undercompensation region increases.

FIG. 6 illustrates an example of the luminance 460 of the undercompensation region, and an example of a luminance 480 adjusted by the additional compensation value. For example, as illustrated in FIG. 6, in the undercompensation region, the luminance 460 of each pixel may be lower than the initial luminance IL by an amount that increases as the degradation amount of the pixel increases. Thus, the display device may determine a first additional compensation value ACV1′ that is a positive value for a first pixel having a first degradation amount DA1 in the undercompensation region. Further, the display device may determine a second additional compensation value ACV2′ that is a positive value for a second pixel having a second degradation amount DA2 that is greater than the first degradation amount DA1 in the undercompensation region. An absolute value of the second additional compensation value ACV2′ may be greater than an absolute value of the first additional compensation value ACV1′. Thus, the luminance of the first pixel may be increased by a first luminance increase amount LI1 by the first additional compensation value ACV1′, and thus may become substantially equal to the initial luminance IL. Further, the luminance of the second pixel may be increased by a second luminance increase amount LI2 that is greater than the first luminance decrease amount LD1 by the second additional compensation value ACV2′, and thus may become substantially equal to the initial luminance IL. Accordingly, the luminance 460 of the undercompensation region may become the luminance 480 that is substantially the same as the initial luminance IL.

Referring to FIG. 1, once the additional compensation value for each pixel in the miscompensation region (e.g., the overcompensation region and/or the undercompensation region) is determined, the display device may re-perform the image-sticking compensation operation on the test data based on the image-sticking compensation data and the additional compensation value (S170). The display device may display a corrected test image based on the test data on which the image-sticking compensation operation is re-performed (S175). For example, the display device may add the compensation value represented by the image-sticking compensation data to the same gray level represented by the test data with respect to each pixel in the remaining region, which is other than the miscompensation region, and may add not only the compensation value represented by the image-sticking compensation data, but also the additional compensation value to the same gray level represented by the test data with respect to each pixel in the miscompensation region.

Further, the display device may receive a visibility evaluation input for the corrected test image from the user through the input device (e.g., predetermined input device) (S180). For example, when the corrected test image has substantially uniform luminance, the user may determine that the corrected test image has good visibility, and the display device may receive the visibility evaluation input indicating the corrected test image has good visibility. Alternatively, when the miscompensation region still has higher or lower luminance than the remaining region, the user may determine that the corrected test image has poor visibility, and the display device may receive the visibility evaluation input representing the corrected test image has poor visibility.

If the visibility evaluation input indicates that the corrected test image has good visibility (OK), the display device may store the additional compensation value for each pixel in the miscompensation region (S190). Thereafter, the display device may generate output image data by performing the image-sticking compensation operation on input image data based on the additional compensation value as well as the image-sticking compensation data. The display device may display an image based on the output image data. For example, the display device may generate the output image data by adding the compensation value represented by the image-sticking compensation data to a gray level represented by the input image data with respect to each pixel in the remaining region other than the miscompensation region. The display device may generate the output image data by adding not only the compensation value represented by the image-sticking compensation data, but also the additional compensation value to a gray level represented by the input image data with respect to each pixel in the miscompensation region. Accordingly, by the image-sticking compensation operation performed based on the image-sticking compensation data and the additional compensation value, image sticking may be removed or reduced in the display device, and the image quality of the display device may be improved.

Alternatively, when the visibility evaluation input indicates that the corrected test image has poor visibility (NG), the display device may again receive the miscompensation region input and the relative brightness input from the user (S120 and S130). The display device may re-determine the additional compensation value for each pixel in the miscompensation region (S140). This re-determination of the additional compensation value may be repeated until the user provides the visibility evaluation input indicating that the corrected test image has good visibility.

As described above, in the method of compensating image sticking in the display device according to embodiments, the miscompensation region input and the relative brightness input may be received from the user, and the additional compensation value for each pixel in the miscompensation region may be determined based on the degradation amount of the pixel, the miscompensation region input and the relative brightness input. Accordingly, the image sticking may be removed or reduced in the display device, and the image quality of the display device may be improved.

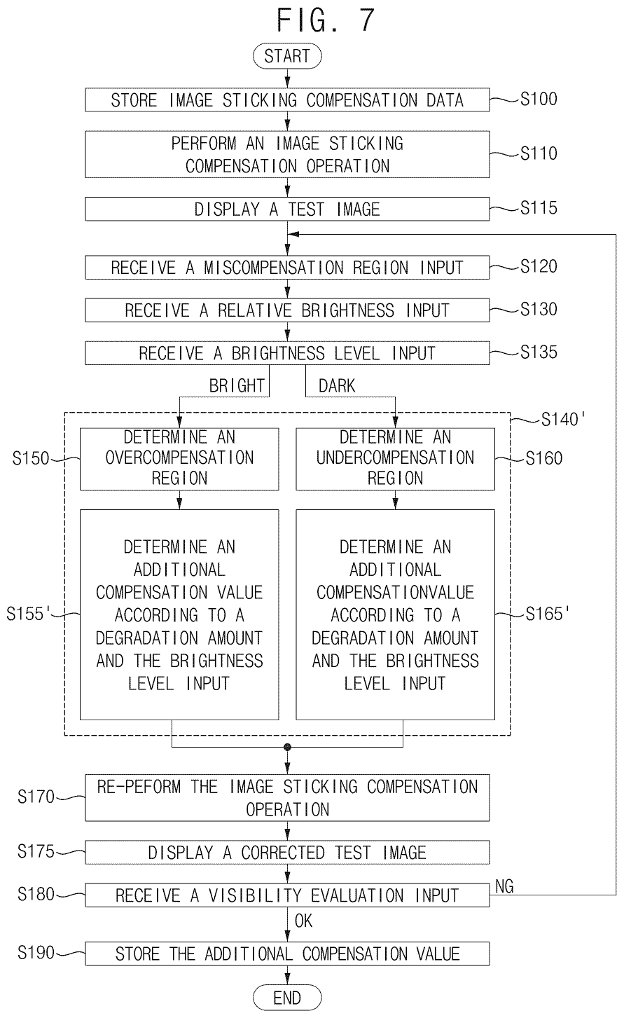

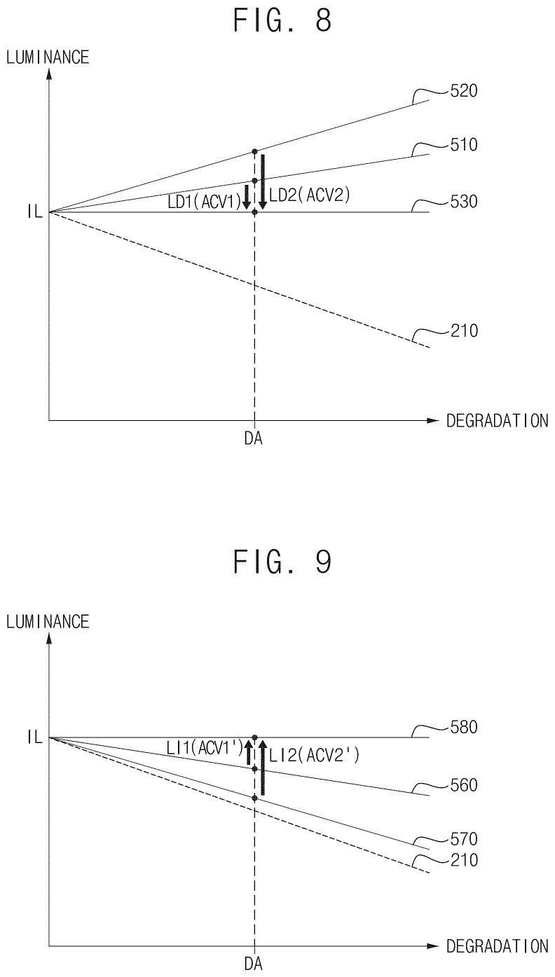

FIG. 7 is a flowchart illustrating a method of compensating image sticking in a display device according to embodiments, and FIG. 8 is a diagram for describing an example of additional compensation values for pixels in an overcompensation region in cases where different brightness level inputs are received.

A method of compensating image sticking illustrated in FIG. 7 may be substantially the same as a method of compensating image sticking illustrated in FIG. 1, except that a brightness level input may be further received from a user, and an additional compensation values may be generated further based on the brightness level input.

Referring to FIG. 7, in a method of compensating image sticking in a display device according to embodiments, the display device may store image-sticking compensation data (or an image-sticking compensation curve) representing a compensation value according to a degradation amount of each pixel of the display device (S100). The display device may perform an image-sticking compensation operation on test data based on the image-sticking compensation data (S110). The display device may display a test image based on the test data on which the image-sticking compensation operation is performed (S115).

The display device may receive a miscompensation region input representing a miscompensation region (or an abnormal compensation region) in the test image from the user (S120). The display device may receive a relative brightness input representing whether the miscompensation region is brighter or darker than a remaining region other than the miscompensation region from the user (S130). The display device may further receive the brightness level input representing a brightness level or a darkness level of the miscompensation region from the user (S140). For example, in a case where the relative brightness input indicates that the miscompensation region is brighter than the remaining region, the brightness level input may indicate that the miscompensation region is brighter by a selected one of two or more brightness levels than the remaining region. Further, in a case where the relative brightness input indicates that the miscompensation region is darker than the remaining region, the brightness level input may indicate that the miscompensation region is darker by a selected one of two or more darkness levels than the remaining region.

The display device may determine an additional compensation value for each pixel in the miscompensation region based on the degradation amount of each pixel in the miscompensation region, based on the miscompensation region input, based on the relative brightness input, and based on the brightness level input (S140′).

If the miscompensation region is brighter than the remaining region (BRIGHT), the display device may determine that the miscompensation region is an overcompensation region (S150). With respect to each pixel in the overcompensation region, the display device may determine the additional compensation value according to the degradation amount of the pixel and the brightness level input (S155′). In some embodiments, the display device may determine the additional compensation value such that an absolute value of the additional compensation value increases as the degradation amount of the pixel increases, and increases as the brightness level input increases.

FIG. 8 illustrates an example of a luminance 510 of the overcompensation region when a first brightness level input is received, illustrates an example of luminance 520 of the overcompensation region when a second brightness level input that is greater than the first brightness level input is received, and illustrates an example of luminance 530 corrected by the additional compensation value. For example, as illustrated in FIG. 8, the display device may determine a first additional compensation value ACV1 that is a negative value with respect to a pixel having a degradation amount (e.g., predetermined degradation amount) DA when the first brightness level input is received, and may determine a second additional compensation value ACV2 that is a negative value, and that has an absolute value that is greater than that of the first additional compensation value ACV1 with respect to the pixel having the degradation amount (e.g., predetermined degradation amount) DA, when the second brightness level input, which is greater than the first brightness level input, is received. Thus, when the first brightness level input is received, the luminance of the pixel may be decreased by a first luminance decrease amount LD1 by the first additional compensation value ACV1, and thus may become substantially equal to an initial brightness IL. Further, when the second brightness level input is received, the luminance of the pixel may be decreased by a second luminance decrease amount LD2 that is greater than the first luminance decrease amount LD1 by the second additional compensation value ACV2, and thus may become substantially equal to the initial luminance IL. Accordingly, the luminance 510 and 520 of the overcompensation region may become the luminance 530 substantially the same as the initial luminance IL.

Alternatively, referring to FIG. 7, if the miscompensation region is darker than the remaining region (DARK), the display device may determine that the miscompensation region is an undercompensation region (S160). With respect to each pixel in the undercompensation region, the display device may determine the additional compensation value according to the degradation amount of the pixel and the brightness level input (S165′). In some embodiments, the display device may determine the additional compensation value such that an absolute value of the additional compensation value increases as the degradation amount of the pixel increases, and increases as the brightness level input increases.

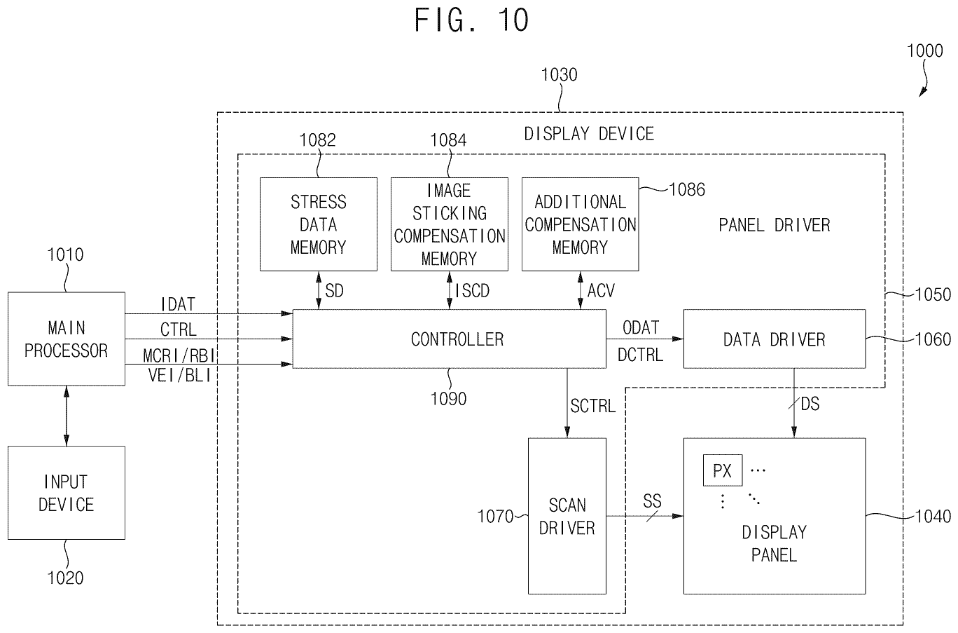

FIG. 9 illustrates an example of a luminance 560 of the undercompensation region when a first brightness level input is received, illustrates an example of luminance 570 of the undercompensation region when a second brightness level input that is greater than the first brightness level input is received, and illustrates an example of luminance 580 corrected by the additional compensation value. For example, as illustrated in FIG. 9, the display device may determine a first additional compensation value ACV1′ that is a positive value with respect to a pixel having a degradation amount (e.g., predetermined degradation amount) DA when the first brightness level input is received. The display device may determine a second additional compensation value ACV2′ that is a positive value, and that has an absolute value that is greater than that of the first additional compensation value ACV1′ with respect to the pixel having the degradation amount (e.g., predetermined degradation amount) DA when the second brightness level input is received. Thus, when the first brightness level input is received, the luminance of the pixel may be increased by a first luminance increase amount LI1 by the first additional compensation value ACV1′, and thus may become substantially equal to the initial brightness IL. Further, when the second brightness level input is received, the luminance of the pixel may be increased by a second luminance increase amount LI2 that is greater than the first luminance increase amount LI1 by the second additional compensation value ACV2′, and thus may become substantially equal to the initial luminance IL. Accordingly, the luminance 560 and 570 of the undercompensation region may become the luminance 580 that is substantially the same as the initial luminance IL.

Once the additional compensation value for each pixel in the miscompensation region (e.g., the overcompensation region and/or the undercompensation region) is determined, the display device may re-perform the image-sticking compensation operation on the test data based on the image-sticking compensation data and based on the additional compensation value (S170). The display device may display a corrected test image based on the test data on which the image-sticking compensation operation is re-performed (S175). The display device may receive a visibility evaluation input for the corrected test image from the user (S180). If the visibility evaluation input indicates that the corrected test image has good visibility (OK), the display device may store the additional compensation value for each pixel in the miscompensation region (S190). Alternatively, when the visibility evaluation input indicates that the corrected test image has poor visibility (NG), the display device may again receive the miscompensation region input, the relative brightness input, and the brightness level input from the user (S120, S130 and S135), and may re-determine the additional compensation value for each pixel in the miscompensation region (S140′).

As described above, in the method of compensating image sticking in the display device according to embodiments, the miscompensation region input, the relative brightness input, and the brightness level input may be received from the user, and the additional compensation value for the pixel in the miscompensation region may be determined based on the degradation amount of each pixel, based on the miscompensation region input, based on the relative brightness input, and based on the brightness level input. Accordingly, the image sticking may be removed or reduced in the display device, and the image quality of the display device may be improved.

FIG. 10 is a block diagram illustrating an electronic device including a display device according to embodiments.

Referring to FIG. 10, an electronic device 1000 according to embodiments may include a main processor 1010, an input device 1020, and a display device 1030. The display device 1030 may include a display panel 1040 that includes a plurality of pixels PX, and a panel driver 1050 that drives the display panel 1040. In some embodiments, the panel driver 1050 may include a data driver 1060 that provides data signals DS to the plurality of pixels PX, a scan driver 1070 that provides scan signals SS to the plurality of pixels PX, a stress data memory 1082 that stores stress data SD, an image-sticking compensation memory 1084 that stores image-sticking compensation data ISCD, an additional compensation memory 1086 that stores an additional compensation value ACV for each pixel PX in a miscompensation region, and a controller 1090 that controls an operation of the display device 1030.

The main processor 1010 may control the overall operation of the electronic device 1000. According to embodiments, the main processor 1010 may be an application processor (AP) including a graphics processing unit (GPU), a central processing unit (CPU), a microprocessor, etc. The main processor 1010 may generate input image data IDAT and a control signal CTRL, and may provide the input image data IDAT and the control signal CTRL to the display device 1030. Further, the main processor 1010 may receive a miscompensation region input MCRI, a relative brightness input RBI, a visibility evaluation input VEI, and/or a brightness level input BLI from the input device 1020.

The input device 1020 may receive the miscompensation region input MCRI representing a miscompensation region in a test image from a user, may receive the relative brightness input RBI representing whether the miscompensation region is brighter or darker than a remaining regions, which are other than the miscompensation region, from the user, and may receive the visibility evaluation input VEI for a corrected test image that is corrected based on the additional compensation value ACV from the user. In some embodiments, the input device 1020 may further receive the brightness level input BLI representing a brightness level or a darkness level of the miscompensation region from the user. The miscompensation region input MCRI, the relative brightness input RBI, the visibility evaluation input VEI, and/or the brightness level input BLI may be provided to the display device 1030 by the input device 1020 (via the main processor 1010). The input device 1020 may be any input device that receives the miscompensation region input MCRI, the relative brightness input RBI, the visibility evaluation input VEI, and/or the brightness level input BLI. For example, the input device 1020 may be, but is not limited to, a remote controller when the electronic device 1000 is a television, a mouse when the electronic device 1000 is a personal computer or a laptop computer, a touch screen when the display device 1030 includes the touch screen, etc.

The display panel 1040 may include a plurality of data lines, a plurality of scan lines, and the plurality of pixels PX connected thereto. In some embodiments, each pixel PX may include a light-emitting element, and the display panel 1040 may be a light-emitting display panel. For example, the light-emitting element may be an organic light-emitting diode (OLED), a nano light-emitting diode (NED), a quantum dot (QD) light-emitting diode, a micro light-emitting diode, an inorganic light-emitting diode, or any other suitable light-emitting element.

The data driver 1060 may generate the data signals DS based on a data control signal DCTRL, and may output image data ODAT received from the controller 1090, and may provide the data signals DS to the plurality of pixels PX through the plurality of data lines. In some embodiments, the data control signal DCTRL may include, but is not limited to, an output data enable signal, a horizontal start signal, and a load signal. In some embodiments, the data driver 1060 and the controller 1090 may be implemented as a single integrated circuit, and the single integrated circuit may be referred to as a timing controller embedded data driver (TED) integrated circuit. In other embodiments, the data driver 1060 and the controller 1090 may be implemented as separate integrated circuits.

The scan driver 1070 may generate the scan signals SS based on a scan control signal SCTRL received from the controller 1090, and may provide the scan signals SS to the plurality of pixels PX through the plurality of scan lines. In some embodiments, the scan control signal SCTRL may include, but is not limited to, a start signal, a clock signal, etc. Further, in some embodiments, the scan driver 1070 may be integrated or formed in the display panel 1040. In other embodiments, the scan driver 1070 may be implemented as one or more integrated circuits.

The stress data memory 1082 may store the stress data SD representing a degradation amount of each pixel PX. For example, the controller 1090 may generate the stress data SD by accumulating the input image data IDAT (or the output image data ODAT), and may store the stress data SD in the stress data memory 1082. The image-sticking compensation memory 1084 may store the image-sticking compensation data ISCD representing a compensation value according to the degradation amount of each pixel PX. For example, the compensation value represented by the image-sticking compensation data ISCD may increase as the degradation amount increases. The additional compensation memory 1086 may store an additional compensation value ACV for each pixel PX in the miscompensation region. The additional compensation value ACV may be generated by a method described above with reference to FIGS. 1 and 7. In some embodiments, each of the stress data memory 1082, the image-sticking compensation memory 1084, and the additional compensation memory 1086 may be located inside the controller 1090 or outside the controller 1090.

The controller 1090 (e.g., a timing controller (T-CON)) may receive the input image data IDAT and the control signal CTRL from the main processor 1010. The control signal CTRL may include, but is not limited to, a vertical synchronization signal, a horizontal synchronization signal, an input data enable signal, and a master clock signal. In some embodiments, the controller 1090 may further receive the miscompensation region input MCRI, the relative brightness input RBI, the visibility evaluation input VEI, and/or the brightness level input BLI from the input device 1020 through the main processor 1010. The controller 1090 may perform an image-sticking compensation operation on the input image data IDAT based on the stress data SD, the image-sticking compensation data ISCD, and/or the additional compensation value ACV to generate the output image data ODAT. For example, to generate the output image data ODAT, the controller 1090 may determine the degradation amount of each pixel PX based on the stress data SD, may add the compensation value corresponding to the degradation amount represented by the image-sticking compensation data ISCD to a gray level represented by the input image data IDAT, and/or may further add the additional compensation value ACV with respect to each pixel PX in the miscompensation region. Further, the controller 1090 may generate the data control signal DCTRL and the scan control signal (SCTRL) based on the control signal CTRL. The controller 1090 may control the data driver 1060 by providing the output image data ODAT and the data control signal DCTRL to the data driver 1060, and may control the scan driver 1070 by providing the scan control signal SCTRL to the scan driver 1070.

In the electronic device 1000 according to embodiments, an operation of determining the additional compensation value ACV may be performed by a user's image-sticking compensation correction input. In response to the image-sticking compensation correction input, the panel driver 1050 may perform an image-sticking compensation operation on test data based on the image-sticking compensation data ISCD, and may drive the display panel 1040 to display a test image based on the test data on which the image-sticking compensation operation is performed. The input device 1020 may receive the miscompensation region input MCRI representing the miscompensation region in the test image from the user, and may receive the relative brightness input RBI representing whether the miscompensation region is brighter or darker than the remaining region other than the miscompensation region from the user. The panel driver 1050 may determine the additional compensation value ACV for each pixel PX in the miscompensation region based on the degradation amount of the pixel PX in the miscompensation region, based on the miscompensation region input MCRI, and based on the relative brightness input RBI. In some embodiments, the panel driver 150 may determine that the miscompensation region is an overcompensation region when the relative brightness input RBI indicates that the miscompensation region is brighter than the remaining region, and may determine that the miscompensation region is an undercompensation region when the relative brightness input RBI indicates that the miscompensation region is darker than the remaining region. The additional compensation value ACV for each pixel PX in the overcompensation region may be a negative value, and the additional compensation value ACV for each pixel PX in the undercompensation region may be a positive value. In some embodiments, an absolute value of the additional compensation value ACV for each pixel PX in the miscompensation region may increase as the degradation amount of each pixel increases. Further, in some embodiments, the panel driver 120 may further receive the brightness level input BLI representing the brightness level or the darkness level of the miscompensation region from the user. For example, an absolute value of the additional compensation value ACV for each pixel PX in the miscompensation region may increase as the brightness level input BLI increases.

As described above, in the electronic device 1000 according to embodiments of the present disclosure, the miscompensation region input MCRI and the relative brightness input RBI may be received from the user, and the additional compensation value ACV for each pixel PX in the miscompensation region may be determined based on the degradation amount of the pixel PX, the miscompensation region input MCRI, and the relative brightness input RBI. Accordingly, the image sticking may be removed or reduced in the display device 1030, and the image quality of the display device 1030 may be improved.

According to embodiments, the electronic device 1000 may be any electronic device including the display device 1030, such as a mobile phone, a smart phone, a tablet computer, a television (TV) (e.g., a digital TV, a 3D TV, etc.), a personal computer (PC), a home appliance, a laptop computer, a personal digital assistant (PDA), a portable multimedia player (PMP), a digital camera, a music player, a portable game console, a navigation device, etc.

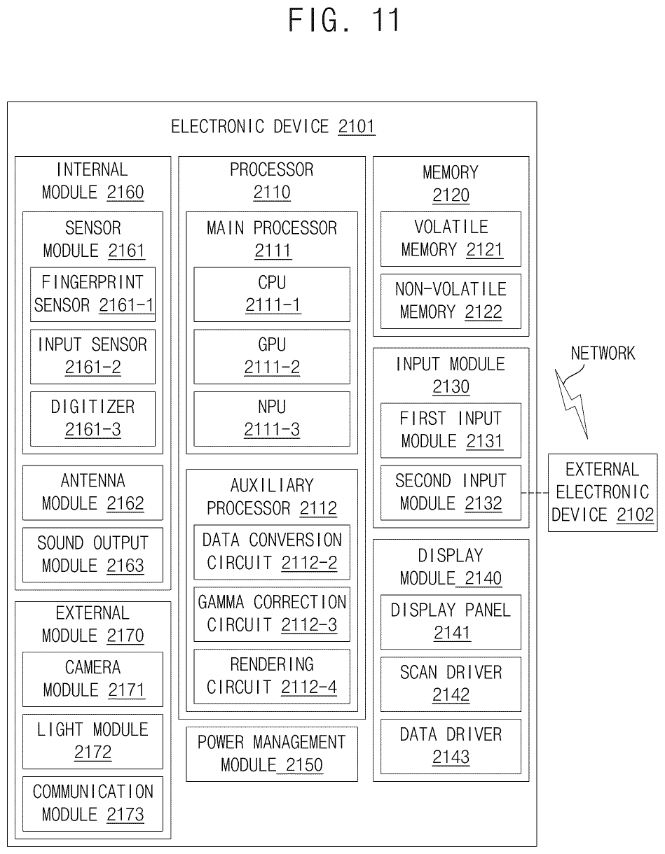

FIG. 11 is a block diagram illustrating an example of an electronic device according to embodiments.

An electronic device 2101 may output various information via a display module 2140 in an operating system. When a processor 2110 executes an application stored in a memory 2120, the display module 2140 may provide application information to a user via a display panel 2141.

The processor 2110 may obtain an external input via an input module 2130 or a sensor module 2161, and may execute an application corresponding to the external input. For example, when the user selects a camera icon displayed in the display panel 2141, the processor 2110 may obtain a user input via an input sensor 2161-2 and may activate a camera module 2171. The processor 2110 may transfer image data corresponding to an image captured by the camera module 2171 to the display module 2140. The display module 2140 may display an image corresponding to the captured image via the display panel 2141.

As another example, when personal information authentication is executed in the display module 2140, a fingerprint sensor 2161-1 may obtain input fingerprint information as input data. The processor 2110 may compare the input data obtained by the fingerprint sensor 2161-1 with authentication data stored in the memory 2120, and may execute an application according to the comparison result. The display module 2140 may display information executed according to application logic via the display panel 2141.

As still another example, when a music streaming icon displayed in the display module 2140 is selected, the processor 2110 obtains a user input via the input sensor 2161-2, and may activate a music streaming application stored in the memory 2120. When a music execution command is input in the music streaming application, the processor 2110 may activate a sound output module 2163 to provide sound information corresponding to the music execution command to the user.

In the above, an operation of the electronic device 2101 has been briefly described. Hereinafter, a configuration of the electronic device 2101 will be described in detail. Some components of the electronic device 2101 described below may be integrated and provided as one component, or one component may be provided separately as two or more components.

Referring to FIG. 11, the electronic device 2101 may communicate with an external electronic device 2102 via a network (e.g., a short-range wireless communication network or a long-range wireless communication network). In some embodiments, the electronic device 2101 may include the processor 2110, the memory 2120, the input module 2130, the display module 2140, a power management module 2150, an internal module 2160, and an external module 2170. In some embodiments, at least one of the components may be omitted from the electronic device 2101, or one or more other components may be added in the electronic device 2101. In some embodiments, some of the components (e.g., the sensor module 2161, an antenna module 2162, or the sound output module 2163) may be implemented as a single component (e.g., the display module 2140).

The processor 2110 may execute software to control at least one other component (e.g., a hardware or software component) of the electronic device 2101 coupled with the processor 2110, and may perform various data processing or computation. According to some embodiments, as at least part of the data processing or computation, the processor 2110 may store a command or data received from another component (e.g., the input module 2130, the sensor module 2161, or a communication module 2173) in a volatile memory 2121, may process the command or the data stored in the volatile memory 2121, and may store resulting data in a non-volatile memory 2122.

The processor 2110 may include a main processor 2111 and an auxiliary processor 2112. The main processor 2111 may include one or more of a central processing unit (CPU) 2111-1 or an application processor (AP). The main processor 2111 may further include any one or more of a graphics processing unit (GPU) 2111-2, a communication processor (CP), and an image signal processor (ISP). The main processor 2111 may further include a neural processing unit (NPU) 2111-3. The NPU 2111-3 may be a processor specialized in processing an artificial intelligence model, and the artificial intelligence model may be generated through machine learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The artificial intelligence model may, additionally or alternatively, include a software structure other than a hardware structure. At least two of the above-described processing units and processors may be implemented as an integrated component (e.g., a single chip), or respective processing units and processors may be implemented as independent components (e.g., a plurality of chips).

The auxiliary processor 2112 may include a controller. The controller may include an interface conversion circuit and a timing control circuit. The controller may receive an image signal from the main processor 2111, may convert a data format of the image signal to meet interface specifications with the display module 2140, and may output image data. The controller may output various control signals for driving the display module 2140.

The auxiliary processor 2112 may further include a data conversion circuit 2112-2, a gamma correction circuit 2112-3, a rendering circuit 2112-4, or the like. The data conversion circuit 2112-2 may receive image data from the controller. The data conversion circuit 2112-2 may compensate for the image data such that an image is displayed with a desired luminance according to characteristics of the electronic device 2101 or the user's setting, or may convert the image data to reduce power consumption or to eliminate an afterimage. The gamma correction circuit 2112-3 may convert image data or a gamma reference voltage so that an image displayed in the electronic device 2101 has desired gamma characteristics. The rendering circuit 2112-4 may receive image data from the controller, and may render the image data in consideration of a pixel arrangement of the display panel 2141 in the electronic device 2101. At least one of the data conversion circuit 2112-2, the gamma correction circuit 2112-3, or the rendering circuit 2112-4 may be integrated in another component (e.g., the main processor 2111 or the controller). At least one of the data conversion circuit 2112-2, the gamma correction circuit 2112-3, or the rendering circuit 2112-4 may be integrated in a data driver 2143 described below.

The memory 2120 may store various data used by at least one component (e.g., the processor 2110 or the sensor module 2161) of the electronic device 2101. The various data may include, for example, input data or output data for a command related thereto. The memory 2120 may include at least one of the volatile memory 2121 or the non-volatile memory 2122.

The input module 2130 may receive a command or data to be used by the components (e.g., the processor 2110, the sensor module 2161, or the sound output module 2163) of the electronic device 2101 from the outside of the electronic device 2101 (e.g., the user or the external electronic device 2102).

The input module 2130 may include a first input module 2131 for receiving a command or data from the user, and a second input module 2132 for receiving a command or data from the external electronic device 2102. The first input module 2131 may include a microphone, a mouse, a keyboard, a key (e.g., a button) or a pen (e.g., a passive pen or an active pen). The second input module 2132 may support a designated protocol capable of connecting the electronic device 2101 to the external electronic device 2102 by wire or wirelessly. In some embodiments, the second input module 2132 may include a high definition multimedia interface (HDMI), a universal serial bus (USB) interface, a secure digital card interface or an audio interface. The second input module 2132 may include a connector that may physically connect the electronic device 2101 to the external electronic device 2102. For example, the second input module 2132 may include an HDMI connector, a USB connector, a secure digital card connector or an audio connector (e.g., a headphone connector).

The display module 2140 may visually provide information to the user. The display module 2140 may include the display panel 2141, a scan driver 2142 and the data driver 2143. The display module 2140 may further include a window, a chassis, and/or a bracket for protecting the display panel 2141.

The display panel 2141 may include a liquid crystal display panel, an organic light-emitting display panel, or an inorganic light-emitting display panel, but the type of the display panel 2141 is not limited thereto. The display panel 2141 may be a rigid type display panel, or a flexible type display panel capable of being rolled or folded. The display module 2140 may further include a supporter, a bracket, or a heat dissipation member that supports the display panel 2141.

The scan driver 2142 may be mounted on the display panel 2141 as a driving chip. Alternatively, the scan driver 2142 may be integrated into the display panel 2141. For example, the scan driver 2142 may include an amorphous silicon thin film transistor (TFT) gate driver circuit (ASG), a low temperature polycrystalline silicon (LTPS) TFT gate driver circuit, or an oxide semiconductor TFT gate driver circuit (OSG) embedded in the display panel 2141. The scan driver 2142 may receive a control signal from the controller, and may output scan signals to the display panel 2141 in response to the control signal.

The display panel 2141 may further include an emission driver. The emission driver may output an emission control signal to the display panel 2141 in response to a control signal received from the controller. The emission driver may be formed separately from the scan driver 2142, or may be integrated into the scan driver 2142.

The data driver 2143 may receive a control signal from the controller, may convert image data into analog voltages (e.g., data voltages) in response to the control signal, and then may output the data voltages to the display panel 2141.

The data driver 2143 may be incorporated into other components (e.g., the controller). Further, the functions of the interface conversion circuit and the timing control circuit of the controller described above may be integrated into the data driver 2143.

The display module 2140 may further include the emission driver, a voltage generator circuit, or the like. The voltage generator circuit may output various voltages used to drive the display panel 2141.

The power management module 2150 may supply power to the components of the electronic device 2101. The power management module 2150 may include a battery that charges a power supply voltage. The battery may include a primary cell that is not rechargeable, a secondary cell that is rechargeable, or a fuel cell. The power management module 2150 may include a power management integrated circuit (PMIC). The PMIC may supply suitable power to each of the modules described above and the modules described below. The power management module 2150 may include a wireless power transmission/reception member electrically connected to the battery. The wireless power transmission/reception member may include a plurality of antenna radiators in the form of coils.

The electronic device 2101 may further include the internal module 2160 and the external module 2170. The internal module 2160 may include the sensor module 2161, the antenna module 2162, and/or the sound output module 2163. The external module 2170 may include the camera module 2171, a light module 2172, and/or the communication module 2173.

The sensor module 2161 may detect an input by the user's body or an input by the pen of the first input module 2131, and may generate an electrical signal or data value corresponding to the input. The sensor module 2161 may include at least one of the fingerprint sensor 2161-1, the input sensor 2161-2, or a digitizer 2161-3.

The fingerprint sensor 2161-1 may generate a data value corresponding to the user's fingerprint. The fingerprint sensor 2161-1 may include any one of an optical type fingerprint sensor and a capacitive type fingerprint sensor.

The input sensor 2161-2 may generate a data value corresponding to coordinate information of the user's body input or the pen input. The input sensor 2161-2 may convert a capacitance change caused by the input into the data value. The input sensor 2161-2 may detect the input by the passive pen, or may transmit/receive data to/from the active pen.

The input sensor 2161-2 may measure a bio-signal, such as blood pressure, moisture, or body fat. For example, when a portion of the body of the user touches a sensor layer or a sensing panel, and does not move for a certain period of time, the input sensor 2161-2 may output information desired by the user to the display module 2140 by detecting the bio-signal based on a change in electric field due to the portion of the body.

The digitizer 2161-3 may generate a data value corresponding to coordinate information of the input by the pen. The digitizer 2161-3 may convert an amount of an electromagnetic change caused by the input into the data value. The digitizer 2161-3 may detect the input by the passive pen, or may transmit/receive data to/from the active pen.

At least one of the fingerprint sensor 2161-1, the input sensor 2161-2, or the digitizer 2161-3 may be implemented as a sensor layer formed on the display panel 2141 through a continuous process. The fingerprint sensor 2161-1, the input sensor 2161-2, and/or the digitizer 2161-3 may be located above the display panel 2141, or at least one of the fingerprint sensor 2161-1, the input sensor 2161-2, or the digitizer 2161-3 may be located below the display panel 2141.

Two or more of the fingerprint sensor 2161-1, the input sensor 2161-2, or the digitizer 2161-3 may be integrated into one sensing panel through the same process. When integrated into one sensing panel, the sensing panel may be located between the display panel 2141 and a window located above the display panel 2141. In some embodiments, the sensing panel may be located on the window, but the location of the sensing panel is not limited thereto.

At least one of the fingerprint sensor 2161-1, the input sensor 2161-2, or the digitizer 2161-3 may be embedded in the display panel 2141. In other words, at least one of the fingerprint sensor 2161-1, the input sensor 2161-2, or the digitizer 2161-3 may be concurrently or substantially simultaneously formed through a process of forming elements (e.g., light-emitting elements, transistors, etc.) included in the display panel 2141.

In addition, the sensor module 2161 may generate an electrical signal or a data value corresponding to an internal state or an external state of the electronic device 2101. The sensor module 2161 may further include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The antenna module 2162 may include one or more antennas for transmitting or receiving a signal or power to or from the outside. In some embodiments, the communication module 2173 may transmit or receive a signal to or from the external electronic device 2102 through an antenna suitable for a communication method. An antenna pattern of the antenna module 2162 may be integrated into one component (e.g., the display panel 2141) of the display module 2140 or the input sensor 2161-2.

The sound output module 2163 may output sound signals to the outside of the electronic device 2101. The sound output module 2163 may include, for example, a speaker or a receiver. The speaker may be used for general purposes, such as playing multimedia or playing record. The receiver may be used for receiving incoming calls. In some embodiments, the receiver may be implemented as separate from, or as part of, the speaker. A sound output pattern of the sound output module 2163 may be integrated into the display module 2140.

The camera module 2171 may capture a still image and a moving image. In some embodiments, the camera module 2171 may include one or more lenses, an image sensor, or an image signal processor. The camera module 2171 may further include an infrared camera capable of measuring the presence or absence of the user, the user's location, and/or the user's line of sight.

The light module 2172 may provide light. The light module 2172 may include a light-emitting diode or a xenon lamp. The light module 2172 may operate in conjunction with the camera module 2171, or may operate independently of the camera module 2171.

The communication module 2173 may support establishing a wired or wireless communication channel between the electronic device 2101 and the external electronic device 2102, and performing communication via the established communication channel. The communication module 2173 may include a wireless communication module (e.g., a cellular communication module, a short-range wireless communication module or a global navigation satellite system (GNSS) communication module) or a wired communication module (e.g., a local area network (LAN) communication module or a power line communication (PLC) module). The communication module 2173 may communicate with the external electronic device 2102 via a short-range communication network (e.g., Bluetooth™ (Bluetooth™ being a registered trademark of Bluetooth Sig, Inc., Kirkland, WA.), wireless-fidelity (Wi-Fi) direct, or infrared data association (IrDA)) or a long-range communication network (e.g., a cellular network, the Internet or a computer network (e.g., LAN or wide area network (WAN)). These various types of communication modules 2173 may be implemented as a single chip, or may be implemented as multi-chips separate from each other.

The input module 2130, the sensor module 2161, the camera module 2171, and the like may be used to control an operation of the display module 2140 in conjunction with the processor 2110.

The processor 2110 may output a command or data to the display module 2140, the sound output module 2163, the camera module 2171, or the light module 2172 based on input data received from the input module 2130. For example, the processor 2110 may generate image data corresponding to input data applied through a mouse or an active pen, and may output the image data to the display module 2140. Alternatively, the processor 2110 may generate command data corresponding to the input data, and may output the command data to the camera module 2171 or the light module 2172. When no input data is received from the input module 2130 for a certain period of time, the processor 2110 may switch an operation mode of the electronic device 2101 to a low power mode or a sleep mode, thereby reducing power consumption of the electronic device 2101.

The processor 2110 may output a command or data to the display module 2140, the sound output module 2163, the camera module 2171, or the light module 2172 based on sensing data received from the sensor module 2161. For example, the processor 2110 may compare authentication data applied by the fingerprint sensor 2161-1 with authentication data stored in the memory 2120, and then may execute an application according to the comparison result. The processor 2110 may execute a command or output corresponding image data to the display module 2140 based on the sensing data sensed by the input sensor 2161-2 or the digitizer 2161-3. In a case where the sensor module 2161 includes a temperature sensor, the processor 2110 may receive temperature data from the sensor module 2161, and may further perform luminance correction on the image data based on the temperature data.

The processor 2110 may receive measurement data about the presence or absence of the user, the location of the user, and/or the user's line of sight from the camera module 2171. The processor 2110 may further perform luminance correction on the image data based on the measurement data. For example, after the processor 2110 determines the presence or absence of the user based on the input from the camera module 2171, the data conversion circuit 2112-2 or the gamma correction circuit 2112-3 may perform the luminance correction on the image data, and the processor 2110 may provide the luminance-corrected image data to the display module 2140.

At least some of the above-described components may be coupled mutually and communicate signals (e.g., commands or data) therebetween via an inter-peripheral communication scheme (e.g., a bus, general purpose input and output (GPIO), serial peripheral interface (SPI), mobile industry processor interface (MIPI) or ultra-path interconnect (UPI)). The processor 2110 may communicate with the display module 2140 via an agreed interface. Further, any one of the above-described communication methods may be used between the processor 2110 and the display module 2140, but the communication method between the processor 2110 and the display module 2140 is not limited to the above-described communication method.

The electronic device 2101 according to various embodiments described above may be various types of devices. For example, the electronic device 2101 may include at least one of a TV (e.g., a digital TV, a 3D TV), a mobile phone, a smart phone, a tablet computer, a personal computer (PC), a home appliance, a laptop computer, a personal digital assistant (PDA), a portable multimedia player (PMP), a digital camera, a music player, a portable game console, or a navigation device.

The foregoing is illustrative of embodiments and is not to be construed as limiting thereof. Although a few embodiments have been described, those skilled in the art will readily appreciate that many modifications are possible in the embodiments without materially departing from the novel teachings and aspects of the present disclosure. Accordingly, all such modifications are intended to be included within the scope of the present disclosure as defined in the claims. Therefore, it is to be understood that the foregoing is illustrative of various embodiments, and is not to be construed as limited to the specific embodiments disclosed, and that modifications to the disclosed embodiments, as well as other embodiments, are intended to be included within the scope of the appended claims.

What is claimed is:

1. A method of compensating image sticking in a display device, the method comprising:
storing image-sticking compensation data representing a compensation value according to a degradation amount of a pixel;
performing an image-sticking compensation operation on test data based on the image-sticking compensation data;
displaying a test image based on the test data;
receiving a miscompensation region input representing a miscompensation region in the test image;
receiving a relative brightness input representing whether the miscompensation region is brighter or darker than a remaining region of the test image that is other than the miscompensation region; and
determining an additional compensation value for the pixel in the miscompensation region based on the degradation amount of the pixel in the miscompensation region, based on the miscompensation region input, and based on the relative brightness input.

2. The method of claim 1, further comprising determining that the miscompensation region is an overcompensation region based on the relative brightness input indicating that the miscompensation region is brighter than the remaining region.

3. The method of claim 2, wherein the additional compensation value for the pixel in the overcompensation region is a negative value.

4. The method of claim 2, wherein an absolute value of the additional compensation value for the pixel in the overcompensation region increases as the degradation amount of the pixel increases.

5. The method of claim 2, wherein determining the additional compensation value for the pixel in the miscompensation region comprises:
determining a first additional compensation value for a first pixel having a first degradation amount in the overcompensation region; and
determining a second additional compensation value for a second pixel having a second degradation amount that is greater than the first degradation amount in the overcompensation region,
wherein the first and second additional compensation values are negative values, and
wherein an absolute value of the second additional compensation value is greater than an absolute value of the first additional compensation value.

6. The method of claim 1, further comprising determining that the miscompensation region is an undercompensation region based on the relative brightness input indicating that the miscompensation region is darker than the remaining region.

7. The method of claim 6, wherein the additional compensation value for the pixel in the undercompensation region is a positive value.

8. The method of claim 6, wherein an absolute value of the additional compensation value for the pixel in the undercompensation region increases as the degradation amount of the pixel increases.

9. The method of claim 6, wherein determining the additional compensation value for the pixel in the miscompensation region comprises:
determining a first additional compensation value for a first pixel having a first degradation amount in the undercompensation region; and
determining a second additional compensation value for a second pixel having a second degradation amount that is greater than the first degradation amount in the undercompensation region,
wherein the first and second additional compensation values are positive values, and
wherein an absolute value of the second additional compensation value is greater than an absolute value of the first additional compensation value.

10. The method of claim 1, wherein the test data represent a same gray level for an entire region of a display panel.

11. The method of claim 1, further comprising:
re-performing the image-sticking compensation operation on the test data based on the image-sticking compensation data and based on the additional compensation value;
displaying a corrected test image based on the test data on which the image-sticking compensation operation is re-performed; and
receiving a visibility evaluation input for the corrected test image.

12. The method of claim 11, further comprising storing the additional compensation value for the pixel in the miscompensation region based on the visibility evaluation input indicating that the corrected test image has good visibility.

13. The method of claim 11, further comprising re-determining the additional compensation value for the pixel in the miscompensation region by again receiving the miscompensation region input and the relative brightness input based on the visibility evaluation input indicating that the corrected test image has poor visibility.

14. A method of compensating image sticking in a display device, the method comprising:
storing image-sticking compensation data representing a compensation value according to a degradation amount of a pixel;
performing an image-sticking compensation operation on test data based on the image-sticking compensation data;
displaying a test image based on the test data;
receiving a miscompensation region input representing a miscompensation region in the test image;
receiving a relative brightness input representing whether the miscompensation region is brighter or darker than a remaining region in the test image that is other than the miscompensation region;
receiving a brightness level input representing a brightness level or a darkness level of the miscompensation region; and
determining an additional compensation value for the pixel in the miscompensation region based on the degradation amount of the pixel in the miscompensation region, based on the miscompensation region input, based on the relative brightness input, and based on the brightness level input.

15. The method of claim 14, wherein an absolute value of the additional compensation value for the pixel in the miscompensation region increases as the brightness level input increases.

16. An electronic device comprising:
an input device; and
a display device comprising:
a display panel; and
a panel driver configured to drive the display panel, configured to store image-sticking compensation data representing a compensation value according to a degradation amount of a pixel of the display panel, configured to perform an image-sticking compensation operation on test data based on the image-sticking compensation data, and configured to drive the display panel to display a test image based on the test data,
wherein the input device is configured to receive a miscompensation region input representing a miscompensation region in the test image, and is configured to receive a relative brightness input representing whether the miscompensation region is brighter or darker than a remaining region in the test image that is other than the miscompensation region, and
wherein the panel driver is configured to determine an additional compensation value for the pixel in the miscompensation region based on the degradation amount of the pixel in the miscompensation region, based on the miscompensation region input, and based on the relative brightness input.

17. The electronic device of claim 16, wherein the panel driver is configured to determine that the miscompensation region is an overcompensation region based on the relative brightness input indicating that the miscompensation region is brighter than the remaining region, or
wherein the panel driver is configured to determine that the miscompensation region is an undercompensation region based on the relative brightness input indicating that the miscompensation region is darker than the remaining region.

18. The electronic device of claim 17, wherein the additional compensation value for the pixel in the overcompensation region is a negative value, or
wherein the additional compensation value for the pixel in the undercompensation region is a positive value.

19. The electronic device of claim 16, wherein an absolute value of the additional compensation value for the pixel in the miscompensation region increases as the degradation amount of the pixel increases.

20. The electronic device of claim 16, wherein the panel driver is configured to receive a brightness level input representing a brightness level or a darkness level of the miscompensation region, and
wherein an absolute value of the additional compensation value for the pixel in the miscompensation region increases as the brightness level input increases.
